(19) United States
(12) Patent Application Publication
(10) Pub. No.: US 2006/0048523 A1
(43) Pub. Date: Mar. 9, 2006

(54) Reciprocating compressor for refrigerator

(76) Inventor: Gi-Bong Kwon, Gimhae (KR)

Correspondence Address: BIRCH STEWART KOLASCH & BIRCH, PO BOX 747, FALLS CHURCH, VA, 22040-0747, US

(21) Appl. No.: 10/539,551

(22) PCT Filed: Jul. 10, 2003
(86) PCT No.: PCT/KR03/01375

§ 371 Date: Jun. 16, 2005

(30) Foreign Application Priority Data
Dec. 20, 2002 (KR) 10-2002-0081891

(51) Int. Cl. C09K 5/04; F04B 39/06; C09K 5/00; F04B 39/02

(52) U.S. Cl. 62/114; 417/366; 252/68

(57) ABSTRACT

A reciprocating compressor with an improved lubrication performance by using a lubricant in harmony with a refrigerant compressed therein, which includes: a hermetic container (6) to which a suction pipe (2) for sucking a refrigerant and a discharge pipe (4) for discharging a compressed refrigerant; a driving unit (8) disposed inside the hermetic container (6) and generating a reciprocal motional force; a compression unit (10) for receiving the reciprocal motional force from the driving unit (8) and compressing an ethane group-based R134a refrigerant; and a lubrication unit (12) for supplying a lubricant to each motional portion of the driving unit (8) and the compression unit (10) and performing a lubricating operation thereon and using an ester-based lubricant, a sort of synthetic fluid with a density of 0.91˜0.99 (15/4° C.)

### TECHNICAL FIELD

The present invention relates to a reciprocating compressor for compressing a refrigerant in a refrigerator and, more particularly, to a reciprocating compressor that is capable of improving a lubricating performance by improving a lubricant used for a reciprocating compressor.

### BACKGROUND ART

As chlorofluorocarbon (CFC), a refrigerant used for a refrigerator, an air-conditioner or the like, has been known as a source material damaging an ozone layer of the stratosphere, researches on a substitute refrigerant are being actively conducted.

The substitute refrigerant for CFC/HCFC is desired to be environment-friendly as well as to have excellent thermodynamical and chemicophysical characteristics. That is, the substitute refrigerant should have a high energy efficiency, a zero ozone layer disintegration index, a low global warming index, no toxic character and incombustibility.

There are a few refrigerants which have no toxicity and no combustibility and are not CFC among methane-based and ethane-based halocarbon compounds: R22, R23, R134a, R123, R124 and R125. Of them, R22, R123 and R124, which are HCFC, are under regulation, and in case of R23, even though it is a kind of HFC, its thermodynamical property is not so good as to be utilized as a refrigerant.

HFC pure refrigerants usable as a substitute refrigerant among halocarbon are very limited. Thus, mixed refrigerants have been studied and developed as substitute refrigerants by mixing two or three pure materials at a suitable composition ratio to make up for shortcomings of the pure materials and thus obtain a good environment index.

R134a, R152a or cyclopropane (RC270) can substitute R12 which has been widely used for the home-use refrigerators and automobile air-conditioners. An HFC mixed refrigerant such as R404A and R507 is being taken into account as a substitute refrigerant of R502 mainly used as a low temperature refrigerant. Meanwhile, HFC mixed refrigerants including R32 are considered as substitute refrigerants of R22 used for a heat pump and various air-conditioning devices. Researches are under way for those substitute refrigerants.

The CFC includes R11 (trichloromonogluoromethane), R12 (dichlorodifluoromethane), R113 and the like, of which R12 largely used as a refrigerant for a refrigerator is one of regulation-subject materials as being a source material causing an ozone layer reduction and generating a global warming effect. Thus, currently, R134a is put to a practical use as a substitute refrigerant of R12.

As a representative example of HCF, R134a exhibits a zero ozone depletion potential, incombustibility and physical properties similar to R12, and is widely used as such.

However, with all those advantages, R134a is hardly combined with refrigerant oil currently used for a refrigerating system of R12 due to its peculiar chemical and electrical properties. Therefore, a refrigerant oil suitable for the refrigerant R134a is in need of development. Especially, necessity of a refrigerant oil usable for a reciprocating compressor for compressing the refrigerant R134a comes to the front.

As shown in FIG. 1, the currently used reciprocating compressor includes: a hermetic container 6 having a suction pipe 2 for sucking a refrigerant and a discharge pipe 4 for discharging a compressed refrigerant each as being connected thereto; a driving unit 8 disposed inside the case 6 and generating a reciprocal motional force; a compression unit 10 for receiving the reciprocal motional force from the driving unit 8 and compressing the refrigerant; and a lubrication unit 12 for lubricating each motional portion of the driving unit 8 and the compression unit 10.

In the reciprocating compressor, when the driving unit is driven and the compression unit makes a compression operation on the refrigerant, the lubrication unit supplies a lubricant stored at the lower portion of the hermetic container to the motional portion of the compression unit, thereby performing a lubricating operation. The refrigerant compressed in the compression unit is R134a.

Since the lubricant used for the reciprocating compressor constructed and operated as described above is used as a refrigerant oil for the compressor compressing the refrigerant R134a, its physical and chemical properties should be in good harmony with the refrigerant R134a.

Namely, the lubricant used as the refrigerant oil of the reciprocating compressor needs to have characteristics that it protects well an oil film even though the refrigerant is dissolved, that it should be thermally and chemically stable so as not to react in spite of being in contact with the refrigerant and an organic material metal at a high temperature or at a low temperature, and that it has a high level of thermal stability so as not to generate a carbon sludge not to be oxidized at a high temperature part of the compressor.

In order to satisfy those characteristics, characters of the lubricant, such as a kinematic viscosity, a pour point, a density, a total acid number, a water content or the like, work as critical factors.

Therefore, if the lubricant used for the reciprocating compressor compressing a refrigerant of a refrigerator is not harmonized with the refrigerant of the refrigerator, the oil would be leaked. Then, oil circulation is deteriorated to degrade a heat transfer performance of the refrigerator and a lubrication performance, resulting in that frictional portions of each motional part are abraded and thus each part is damaged.

### DISCLOSURE OF THE INVENTION

Therefore, it is an object of the present invention to provide a reciprocating compressor with an improved lubrication performance by using a lubricant in harmony with a refrigerant compressed therein.

To achieve these objects, there is provided a reciprocating compressor for a refrigerator including: a hermetic container having a suction pipe and a discharge pipe connected thereto; a driving unit having a stator fixed inside the hermetic container and a mover disposed spaced apart from the stator and linearly and reciprocally moved by interaction with the stator when power is applied to the stator, an HFC refrigerant sucked into the suction pipe, being hydrogenated carbon fluoride and not including chlorine; a compression unit for compressing the HFC refrigerant upon receiving a reciprocal motional force generated from the driving unit; an ester-based lubricant, a sort of synthetic fluid, filled at the lower portion of the hermetic container and having a high moisture absorption and a saturated water amount of 1500˜2000 PPM; and a lubrication unit for supplying the ester-based lubricant to each motional portions of the driving unit and the compression unit and making a lubricating operation.

In the reciprocating compressor of the present invention, the stator consists of an outer stator fixed at the hermetic container; an inner stator disposed with a certain air gap with an inner circumferential surface of the outer stator; and a winding coil wound at one of the outer stator and the inner stator, to which power is applied from an external source, and the mover consists of a magnet disposed between the outer stator and the inner stator and being linearly and reciprocally moved when power is applied to the winding coil; a magnet frame having magnets mounted thereon; and a piston connected to the magnet frame and compressing a fluid while being linearly and reciprocally moved.

In the reciprocating compressor of the present invention, the compression unit includes: a piston connected to the mover and linearly and reciprocally moved; a cylinder, into which the piston is slidably inserted, for forming a certain compression chamber; a suction valve mounted at a refrigerant passage formed at the piston and preventing a backflow of the refrigerant after being introduced into the compression chamber; and a discharge valve mounted at a front side of the cylinder and performing an opening and closing operation on a compressed refrigerant.

In the reciprocating compressor of the present invention, the lubrication unit includes: a lubricant pumping unit for pumping the ester-based lubricant filled as much as a certain amount at a lower portion of the hermetic container; and a lubricant supply passage for supplying the ester-based lubricant pumped by the lubricant pumping unit to a frictional portion between the piston and the cylinder.

In the reciprocating compressor of the present invention, the refrigerant has a zero ODP (ozone depletion potential) and incombustible.

In the reciprocating compressor of the present invention, HFC134a with a purity of above 99.9%, a molecular formula of CF₃CFH₂ and a molecular weight of 102 is used as the refrigerant.

In the reciprocating compressor of the present invention, the lubricant has a density of 0.93˜0.99 g/cm₃ at a temperature of 15° C. and a total acid number of below 0.01 mgKOH/g.

In the reciprocating compressor of the present invention, the lubricant has a flash point of below 240° C. and a kinematic viscosity of 10.0˜22.5 mm²/s at a temperature of 40° C.

In the reciprocating compressor of the present invention, the lubricant contains additives such as a stabilizer, an antioxidant and the like.

### BRIEF DESCRIPTION OF THE DRAWINGS

FIG. 1 is a sectional view of a reciprocating compressor for a general refrigerator.

### MODES FOR CARRYING OUT THE PREFERRED EMBODIMENTS

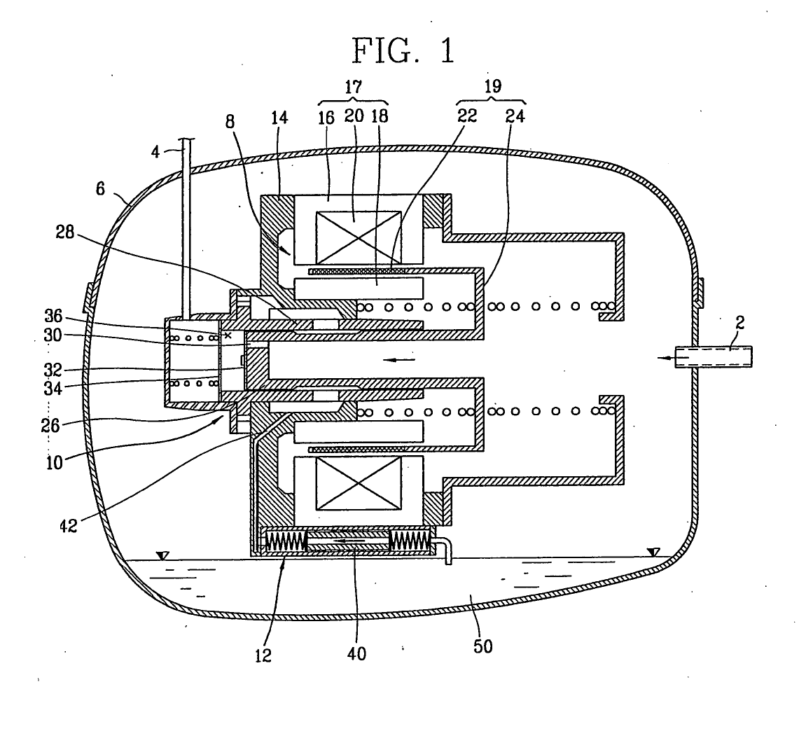

FIG. 1 is a sectional view of a general reciprocating compressor.

As shown in FIG. 1, a general reciprocating compressor includes a hermetic container 6 to which a suction pipe 2 for sucking a refrigerant and a discharge pipe 4 for discharging a compressed refrigerant are connected, a driving unit 8 disposed inside the case 6 and generating a reciprocal motional force; a compression unit 10 for receiving the reciprocal motional force generated from the driving unit 8 and compressing the refrigerant; and a lubrication unit 12 for performing a lubricating operation on each motional portion of the driving unit 8 and the compression unit 10.

The driving unit 8 consists of a stator 17 fixed inside the hermetic container, and a mover 19 disposed spaced apart from the stator 17 and linearly and reciprocally moved by an interaction with the stator 17 when power is applied to the stator 17.

The stator 17 includes a cylindrical outer stator 16 fixed by a support frame 14 fixed inside the hermetic container, an inner stator disposed with a certain air gap with an inner circumferential surface of the outer stator 16, and a winding coil 20 wound inside the outer stator 16 to which power is applied from an external source.

The mover 19 includes a magnet 22 disposed with a certain space between the outer stator 16 and the inner stator 18 and linearly and reciprocally moved when power is applied to the winding coil 20, and a magnet holder 24 having magnets mounted at equal intervals at its outer circumferential surface and being connected to a piston 26 of the compression unit 10.

The compression unit 10 includes a piston 26 connected to the magnet holder 24 and linearly and reciprocally moved; a cylinder 28 into which the piston 26 is slidably inserted to form a certain compression chamber 36; a suction valve 32 mounted at a refrigerant passage 30 formed at the piston 26 and preventing a backflow of the refrigerant after being introduced into the compression chamber 36; and a discharge valve 34 mounted at the front side of the cylinder 28 and performing an opening and closing operation on a compressed refrigerant.

The lubrication unit 12 includes a lubricant 50 filled with a certain amount at the lower portion of the hermetic container 6; a lubricant pumping unit 40 for pumping the lubricant 50; and a lubricant supply passage 42 for supplying the lubricant 50 pumped by the lubricant pumping unit 40 to a frictional portion between the piston 26 and the cylinder 28.

The operation of the general reciprocating compressor constructed as described above will now be explained.

When power is applied to the winding coil 20, a flux is formed around the winding coil 20, forming a closed loop along the outer stator 16 and the inner stator 18. By the interaction of the flux formed between the outer stator 16 and the inner stator 18 and the flux formed by the magnet 22, the magnet 22 is linearly moved in an axial direction. When the direction of a current applied to the winding coil 20 is changed in turn, the magnet 22 is linearly and reciprocally moved as the direction of the flux of the winding coil 20 is changed.

Then, the motion of the magnet 22 is transferred to the piston 26 by the magnet holder 24, and accordingly, the piston 26 is linearly and reciprocally moved inside the cylinder 28, thereby performing a compressing operation on the refrigerant.

That is, when the piston 26 is retreated, the refrigerant introduced into the suction pipe 2 is supplied to the compression chamber 36 through the suction passage 30 formed at the piston 26. Meanwhile, when the piston 26 advances, the suction passage 30 is closed by the suction valve 32, the refrigerant inside the compression chamber 36 is compressed, and the compressed refrigerant is is externally discharged through the discharge pipe 4.

During the compressing operation, the lubricant 50 filled in the hermetic container 6 is pumped according to operation of the lubricant pumping unit 40 and supplied to the frictional portion between the piston 26 and the cylinder 28 through the lubricant supply passage 42, for a lubricating operation.

As the refrigerant compressed by the reciprocating compressor constructed and operated as described above, the HFC refrigerant, hydrogenated carbon fluoride comprising hydrogen, fluorine and carbon without chlorine, is used which has a high energy efficiency and a zero ODP (ozone depletion potential), is incombustible, and has a low global warming index, no toxicity and incombustibility.

Specifically, R32, R143a, R152a and the like are used as the HFC refrigerant, and HFC134a is preferably used for the current refrigerator as it has a purity of above 99.9%, a molecular formula CF₃CFH₂ and a molecular weight of 102.

As the lubricant of the reciprocating compressor for which the HFC34a refrigerant is used, an ester-based lubricant, a sort of synthetic fluid, is used as it has a good compatibility with the refrigerant and satisfies physical and chemical characteristics.

The density of the ester-based lubricant is preferably 0.93˜0.99 g/cm³ at a temperature of 15° C.

Preferably, a total acid number of the ester-based lubricant is adopted by below 0.01 mgKOH/g.

The total acid number of the lubricant, representing an amount of an acid component contained in an oil, indicates an amount of potassium hydroxide required for neutralizing an acid component contained in 1 g of sample oil by the number of mg. Since the lubricant used for the refrigerator should be absolutely neutral, the total acid number works as a basis for determining a deterioration level of the refrigerant oil.

A flash point of the ester-based lubricant varies depending on a size and a type of the reciprocating compressor. Preferably, it is below 240° C., and it can be below 165° C., below 175° C., below 185° C. and below 200° C. according to the type of an adopted compressor.

A kinematic viscosity (cSt) of the ester-based lubricant is preferably 10.0˜22.5 mm²/s at a temperature of 40° C.

A saturated water amount of the ester-based lubricant is preferably 1500˜2000 PPM. The moisture contained in the lubricant should be maintained by below a suitable level because it causes freezing, sludge generation and corrosion.

A breakdown voltage of the ester-based lubricant is preferably above 30 KV.

As so far described, the reciprocating compressor for a refrigerator of the present invention has such an advantage that since it uses the ester-based lubricant, a sort of a synthetic fluid with an excellent compatibility with an ethane group-based R134a refrigerant compressed by the reciprocating compressor, the lubricating performance is improved and a life span of the reciprocating compressor is lengthened.

It will be apparent to those skilled in the art that various modifications and variations can be made in the reciprocating compressor for a refrigerator of the present invention without departing from the spirit or scope of the invention. Thus, it is intended that the present invention cover modifications and variations of this invention provided they come within the scope of the appended claims and their equivalents.

1. A reciprocating compressor for a refrigerator comprising:
a hermetic container having a suction pipe and a discharge pipe connected thereto;
a driving unit having a stator fixed inside the hermetic container and a mover disposed spaced apart from the stator and linearly and reciprocally moved by interaction with the stator when power is applied to the stator;
an HFC refrigerant sucked into the suction pipe, being hydrogenated carbon fluoride and not including chlorine;
a compression unit for compressing the HFC refrigerant upon receiving a reciprocal motional force generated from the driving unit;
an ester-based lubricant, a sort of synthetic fluid, filled at the lower portion of the hermetic container and having a high moisture absorption and a saturated water amount of 1500˜2000 PPM; and
a lubrication unit for supplying the ester-based lubricant to each motional portions of the driving unit and the compression unit and making a lubricating operation.

2. The reciprocating compressor of claim 1, wherein the stator consists of an outer stator fixed at the hermetic container; an inner stator disposed with a certain air gap with an inner circumferential surface of the outer stator; and a winding coil wound at one of the outer stator and the inner stator, to which power is applied from an external source, and
the mover consists of a magnet disposed between the outer stator and the inner stator and being linearly and reciprocally moved when power is applied to the winding coil; a magnet frame having magnets mounted thereon; and a piston connected to the magnet frame and compressing a fluid while being linearly and reciprocally moved.

3. The reciprocating compressor of claim 1, wherein the compression unit comprises:
a piston connected to the mover and linearly and reciprocally moved;
a cylinder, into which the piston is slidably inserted, for forming a certain compression chamber;
a suction valve mounted at a refrigerant passage formed at the piston and preventing a backflow of the refrigerant after being introduced into the compression chamber; and
a discharge valve mounted at a front side of the cylinder and performing an opening and closing operation on a compressed refrigerant.

4. The reciprocating compressor of claim 1, wherein the lubrication unit comprises:
a lubricant pumping unit for pumping the ester-based lubricant filled as much as a certain amount at a lower portion of the hermetic container; and
a lubricant supply passage for supplying the ester-based lubricant pumped by the lubricant pumping unit into a frictional portion between the piston and the cylinder.

5. The reciprocating compressor of claim 1, wherein the refrigerant has a zero ODP (ozone depletion potential) and incombustible.

6. The reciprocating compressor of claim 1, wherein HFC134a with a purity of above 99.9%, a molecular formula of CF₃CFH₂ and a molecular weight of 102 is used as the refrigerant.

7. The reciprocating compressor of claim 1, wherein the lubricant has a density of 0.93˜0.99 g/cm₃ at a temperature of 15° C. and a total acid number of below 0.01 mgKOH/g.

8. The reciprocating compressor of claim 1, wherein the lubricant has a flash point of below 240° C. and a kinematic viscosity of 10.0˜22.5 mm²/s at a temperature of 40° C.

9. The reciprocating compressor of claim 1, wherein the lubricant contains additives such as a stabilizer, an antioxidant and the like.
